(19) United States
(12) Patent Application Publication
(10) Pub. No.: US 2025/0315234 A1
(43) Pub. Date: Oct. 9, 2025

(54) INTENT-BASED SERVICE POLICY DECLARATION AND CONFIGURATION

(71) Applicant: Dell Products L.P., Round Rock, TX (US)

(72) Inventors: JUAN PABLO JOFRE, Black Diamond, WA (US); PATRICK JOSEPH O'ROURKE, Lunenburg, MA (US); GAURI ANIL WAGLE, Austin, TX (US); DAVID KIMBLE WOODS, Snoqualmie, WA (US); DIEGO MARIO GEFFNER, Seattle, WA (US); RUBEN GARCIA, Round Rock, TX (US); CHING-YUN CHAO, Austin, TX (US); ANDREW RAYMOND FAUSAK, Colleyville, TX (US)

(21) Appl. No.: 18/625,550

(22) Filed: Apr. 3, 2024

(51) Int. Cl. G06F 8/60

(52) U.S. Cl. CPC G06F 8/60

(57) ABSTRACT

Methods and systems for managing services (e.g., the development, deployment, and configuration of services) are disclosed. User intent associated with policy related configurations for computer implemented services are directly and automatically translated into a set of user intended network policy and rules to be applied (e.g., enforced) by the computer implemented services without any need for the user to understand how the policies will be configured and implemented by the service deployment environment.

### FIELD

Embodiments disclosed herein relate generally to configuration and deployment of services. More particularly, embodiments disclosed herein relate to systems and methods to configuration and deployment of services based on intent-based service policy declaration.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a data flow diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing services (e.g., computer implemented services such as microservices or the like). To manage and provide various computer implemented services (also referred to herein simply as “services”), information regarding policies (e.g., privacy related policies, access control policies, or the like) that the computer implemented services are to adhere to and/or enforce are required.

Namely, deploying such computer implemented services with incomplete or incorrect policy configurations can lead to disadvantageous side effects such as: higher maintenance overheard, non-compliant (e.g., governmental compliance, inter-entity compliance, or the like) computer implemented services, and security vulnerabilities. However, configuring complete and correct policy configurations requires: a high-level ofnetwork domain expertise, and a deep understanding of a network's (e.g., the network in which the services are deployed) topology and of the infrastructure of the specific service deployment environment that most developers (e.g., customers, employees, development teams, or the like) may not have.

To better, and more easily and conveniently, ensure that services are being developed and/or deployed with complete and correct policies without access to such persons with the above-required level of skills, embodiments disclosed herein provide systems and methods that allow a developer's (or other similar entities) intent to be directly translated into complete and correct policies to be applied to one or more new and/or existing services.

More specifically, using one or more embodiments, developers will simply be able to declare the developer's intended isolation and protection requirements for services to be developed, deployed, and/or implemented and such intended/declared isolation and protection will be automatically implemented by (e.g., applied to) one or more new and/or existing services. Such automation of policy configurations may also advantageously be agnostic to different deployment environments, which would further simplify the developer's task of implementing complete and correct policy configurations for these services.

Thus, embodiments disclosed herein may address, among others, the technical problem of implementing services with incomplete or incorrect policy configurations, which would advantageously reduce and/or eliminate the above discussed disadvantageous side effects associated with such scenarios. This directly results in direct improvements (e.g., security vulnerability improvements, more effective resource usage, lower system maintenance requirements, or the like) to computers implementing such computer implemented services.

Additionally, an improved system where even inexperienced developers will not have concerns regarding deploying services with incomplete or incorrect policy configurations can also be achieved.

In an embodiment, a method for managing services is provided. The method may include: obtaining a service management request; parsing the service management request to obtain intent data; using the intent data to obtain one or more policy and rules templates from a policy and rules repository; generating service management instructions using the one or more policy and rules templates and the intent data, the service management instructions comprising a set of user intended network policy and rules; and providing the service management instructions to one or more service devices providing the services to cause the one or more service devices to apply the set of user intended network policy and rules to one or more existing or new instances of the services.

The intent data is associated with at least one of a service visibility configuration, a service accessibility configuration, or a service control configuration of the services.

Parsing the service management request to obtain intent data may include: parsing a natural language statement or information associated with a human action or selection included in the service management request, the natural language statement or the information associated with the human action or selection comprising at least one of a service visibility intent, a service accessibility intent, or a service control intent that affects the service visibility configuration, the service accessibility configuration, or the service control configuration, respectively, of the services.

Each of the one or more policy and rules templates comprises at least one of a first symbolic name or a second symbolic name.

The first symbolic name is resolved by a service development tool at a service development time and the second symbolic name is resolved by a continuous delivery/continuous deployment (CD) pipeline at a service deployment time.

The set of user intended network policy and rules constructed from the one or more policy and rules templates are associated with at least one of public application programming interfaces (APIs), external APIs, internal APIs, or private APIs.

The service management request is obtained from a client device requesting the services provided by the one or more service devices, the one or more existing or new instances of the services applied with the set of user intended network policy and rules are provided to the client device, and the client device does not have access to any policy and rules included in the one or more policy and rules templates stored in the policy and rules repository for guiding a user of the client device during a generation of the service management request.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

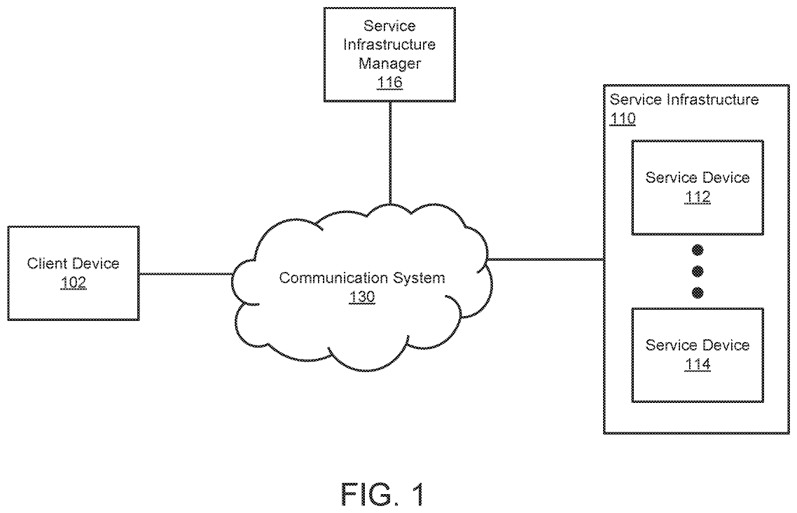

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, microservices (e.g., an application architecture where a collection of independent services communicate through various types of application programming interfaces (APIs)), and/or any other type of service that may be implemented with a computing device.

To provide the computer implemented services, workloads may be performed by various components of the system. To perform the workloads, various information may need to be obtained. Similarly, when workloads are performed various types of new information may become available for use.

The information used in the workloads may be available from various devices of the system. To facilitate access to the information, any of the devices of the system may host instances of application programming interfaces (APIs). The APIs may be used by other devices and/or applications (e.g., hosted by other or the same device) to obtain data that may include information usable in workloads.

To facilitate ease of use, any of the APIs may be implemented as Representational State Transfer (REST) APIs. The REST APIs may associate uniform resource identifiers (URIs) with various resources (e.g., data sources). The resources may have various properties corresponding to different types of data available via the REST APIs. The data may be stored in a database which the REST APIs may receive when requests directed to the URIs are received.

To provide for the above noted functionality, the system of FIG. 1 may include client device 102, service infrastructure 110, service infrastructure manager 116, and communication system 130. Each of these components is discussed below.

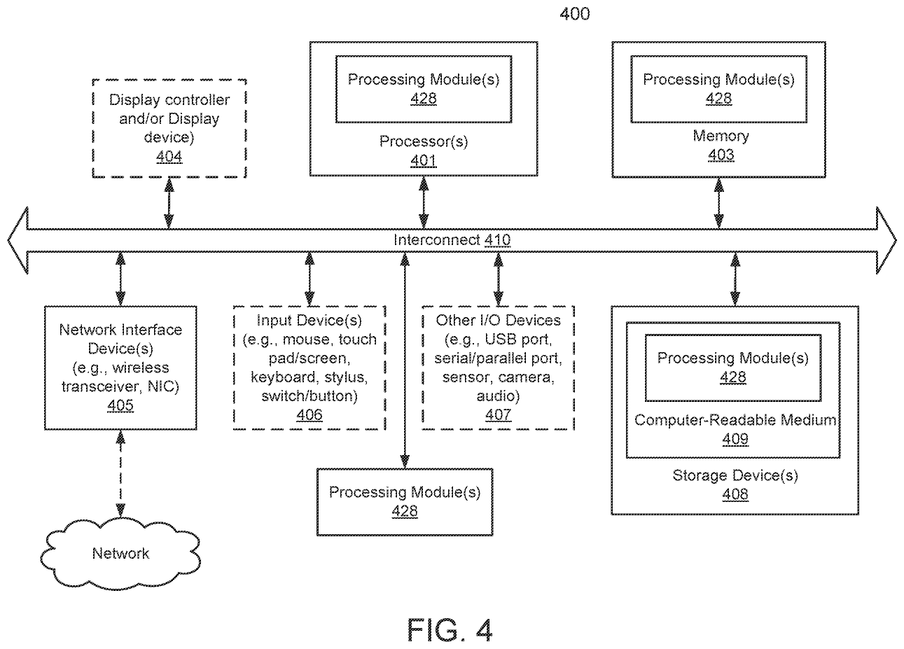

Client device 102 may be implemented as a computing device (also referred to as a data processing system) such as a host or a server, a personal computer (e.g., desktops, laptops, and tablets), a “thin” client, a personal digital assistant (PDA), a Web enabled appliance, a virtual host, a virtual computer, a mobile phone (e.g., Smartphone), an embedded system, local controllers, an edge node, and/or any other type of physical and/or virtual data processing device or system. For additional details regarding computing devices, refer to FIG. 4.

Client device 102 may be used by a developer (e.g., of services) to configure one or more parameters (e.g., content, functions, policies, or the like) of one or more new and/or existing services (or instances of the services). Although FIG. 1 shows only a single client device 102, the system in FIG. 1 may contain any number of client devices 102.

Service infrastructure 110 may provide desired computer implemented services. In particular, the service infrastructure 110 may be an environment (e.g., within a network infrastructure/topology) in which the computer implemented services are developed and/or deployed. To do so, service infrastructure 110 may include any number of service devices (e.g., 112-114). The service devices may provide (e.g., deploy, implement, execute, or the like) the computer implemented services cooperatively and/or individually.

Each of the service devices (e.g., 112-114) may be implemented as one or more computing devices (also referred to as a data processing system) such as a host or a server, a personal computer (e.g., desktops, laptops, and tablets), a “thin” client, a personal digital assistant (PDA), a Web enabled appliance, a virtual host, a virtual computer, a mobile phone (e.g., Smartphone), an embedded system, local controllers, an edge node, and/or any other type of physical and/or virtual data processing device or system. For additional details regarding computing devices, refer to FIG. 4.

Each of the service devices (e.g., 112-114) may be configured (e.g., equipped) with all of the computing resources (e.g., hardware and/or software resources) required to implement the computer implemented services. The types of computing resources configured in each device may vary based on the type of computer implemented services being provided by each device (or collection of devices). The types of computing resources configured in each device may also be pre-determined and continuously updated by an entity (e.g., an individual, a corporation, or the like) that is providing the computer implemented services.

For example, service devices (e.g., 112-114) may, singly or in combination, be configured as a microservices architecture that provides one or more microservices. In particular, service devices (e.g., 112-114) may include various integrated building blocks that support any application architecture, regardless of scale, load, or complexity. In embodiments, service infrastructure 110 may be configured to include multiple microservice architectures.

Such computer implemented services (e.g., once developed and deployed by the service devices (e.g., 112-114) of the service infrastructure 110) may be provided back to the client device 102 (and/or any other computing devices connected to communication system 130).

Similar to client device 102 and the service devices (e.g., 112-114) of the service infrastructure 110, service infrastructure manager 116 may also be implemented as one or more computing devices (also referred to as a data processing system) such as a host or a server, a personal computer (e.g., desktops, laptops, and tablets), a “thin” client, a personal digital assistant (PDA), a Web enabled appliance, a virtual host, a virtual computer, a mobile phone (e.g., Smartphone), an embedded system, local controllers, an edge node, and/or any other type of physical and/or virtual data processing device or system. For additional details regarding computing devices, refer to FIG. 4.

Service infrastructure manager 116 may be configured to manage the service devices (e.g., 112-114) of the service infrastructure 110. Namely, service infrastructure manager 116 may be configured to manage the policies (e.g., network policies, virtual service rules, or the like) implemented (e.g., applied, enforced, or the like) by the computer implemented services being offered by the service infrastructure 110.

In embodiments, service infrastructure manager 116 may be configured to compile the polic(ies) to be applied to and/or enforced by the computer implemented services. To compile such polic(ies), the service infrastructure manager 116 may include a policy and rules repository that stores one or more policy and rules templates. Although not shown in FIG. 1, the policy and rules repository may be implemented as a stand-alone remote storage device (e.g., a remote storage server, or the like) separate from all of the client device 102, the service infrastructure manager 116, and the service devices (e.g., 112-114).

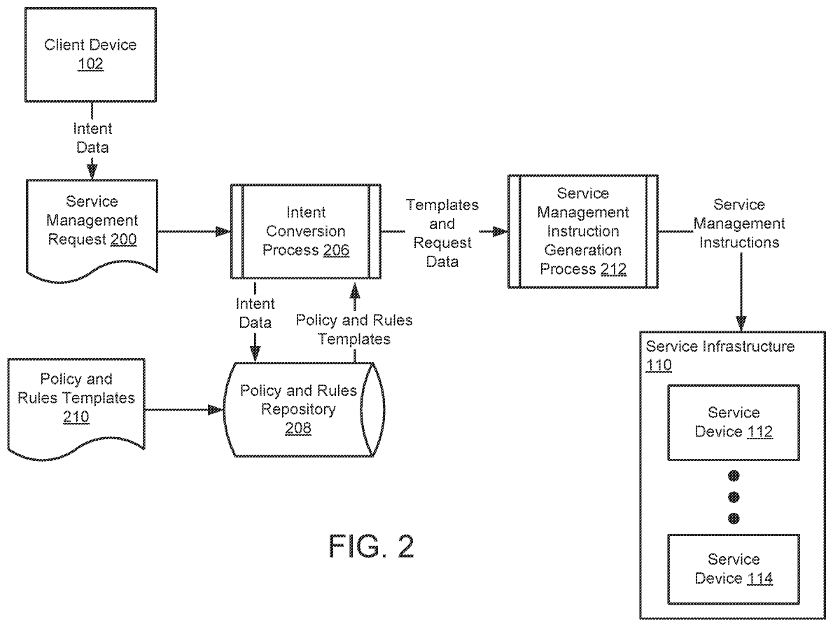

Additional details regarding the policy and rules repository and the one or more policy and rules templates will be discussed below in reference to FIG. 2.

Although the service infrastructure manager 116 is shown in FIG. 1 as a stand-alone device separate from the service infrastructure 110, in embodiments, the service and infrastructure manager 116 may be provided as part of the service infrastructure 110. In particular, in one example, the service infrastructure manager 116 may be another physical and/or virtual device within the service infrastructure 110 in addition to the service devices (e.g., 112-114). In yet another example, each service device 112-114 of service infrastructure 110 may include internally (e.g., as hardware, software, or a combination of both) all parts of the service infrastructure manager 116.

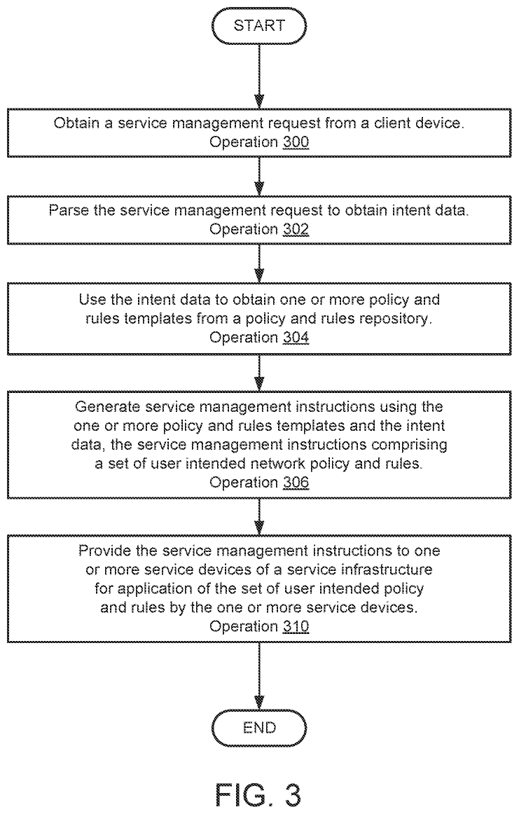

When providing their functionality, any of client device 102, the service infrastructure 110 (and/or a portion thereof), and the service infrastructure manager 116 may perform one or more portions of the flows and methods illustrated in FIGS. 2-3.

Any of the components illustrated in FIG. 1 may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIG. 2. In these diagrams, flows of data and processing of data are illustrated using different sets of shapes. A first set of shapes (e.g., 200, 210, etc.) is used to represent data structures, a second set of shapes (e.g., 206, 212, etc.) is used to represent processes performed using and/or that generate data, a third set of shapes (e.g., 208, etc.) is used to represent large scale data structures such as databases, and a fourth set of shapes (e.g., 102, 112, 114, etc.) is used to represent computing devices (e.g., a computing device as shown in FIG. 4).

Turning to FIG. 2, a service management request 200 is generated by client device 102 (e.g., via input of one or more pieces of information by a user of client device 102). The service management request 200 may include data (e.g., functionality data, policy data, or the like) associated with the generation (e.g., development and deployment) of one or more new computer implemented services and/or associated with the configuration (e.g., updating, modification of, or the like) of one or more existing (e.g., already deployed) computer implemented services (and/or instances of the computer implemented services). In embodiments, the service management request 200 may also be a service management operation (e.g., realized as a click of a button, a selection of an attribute/parameter from a list, or the like by the user of the client device 102 through using an intent-based user interface (UI) displayed to the user on a display of the client device 102).

In embodiments, one of the pieces of information input by the user of client device 102 may include intent data associated with the user's (e.g., a developer's) intended isolation and protection (e.g., at least one of a service visibility intent, a service accessibility intent, a service control intent, or the like that affects the service visibility, the service accessibility configuration, the service control configuration, respectively, (or the like) of the computer implemented services) for one or more of the new and/or existing instances of computer implemented services.

In embodiments, such intent data may include, for example: a user's (e.g., developer's) intended visibility (e.g., public, internal, private API visibility, or the like) for one or more of the computer implemented services; access control (e.g., role-based access control (RBAC), access conditions, security-related control and/or conditions, or the like) intents for one or more of the computer implemented services; compliance (e.g., governmental guidelines compliance, entity internal polic(ies) compliance, client polic(ies) compliance, or the like) intents; and/or any other similar network policy and/or virtual service rules related configurations for the computer implemented services. Said another way, the intent data may be associated with at least one of a service visibility configuration, a service accessibility configuration, a service control configuration, or the like of the computer implemented services.

In embodiments, such intended policies may be scoped to one or more computer implemented services (e.g., microservices) while aligning with one or more continuous integration and continuous delivery/continuous deployment (CI/CD) processes associated with the development and deployment of such computer implemented services.

In embodiments, such intent data may be received by the client device 102 through various input means. For example, the client device 102 may be configured to display a graphical user interface (GUI) to a user to guide the user in the selection of the user's intended isolation and protection policies for the computer implemented services. As another example, the GUI may receive the intent data as an input of one or more terms (e.g., a natural language statement including separated terms, one or more full sentence, or the like) by a user (e.g., “I would like this service to be private and only I or anyone with higher authorization than me can access this service.”). As yet another example, the intent data may be recorded in a file (e.g., a WORD file, a text file, a PDF file, or the like) and the file including the natural language statement may be provided to the client device 102.

As shown in FIG. 2, the service management request is ingested by an intent conversion process 206. In embodiments, the intent conversion process 206 may be executed by any of the client device 102, the service devices (e.g., 112-114), and/or the service infrastructure manager 116 as shown in FIG. 1.

As part of the intent conversion process 206, the intent data included in the service management request is identified and processed. For example, if the intent data is in the form of the natural language statement (e.g., whether received as a direct input or included within one or more files submitted to the client device 102, or the like), the intent conversion process 206 applies one or more natural language processing techniques to identify (e.g., determine) the developer's intended network policies (and/or virtual services rules) for each computer implemented services specified in the service management request 200.

As another example, if the intent data is based on input through selection of various policy options through a GUI, the intent conversion process 206 may involve identifying tags (or the use of any similar techniques) associated with each selection that identifies the selection as policy related data.

Using the intent data, the intent conversion process 206 parses a policy and rules repository 208 to retrieve one or more policy and rules templates 210 that are consistent with the intended isolation and protection defined by the developer. In particular, policy and rules repository 208 may be implemented as a database (e.g., a partition within a storage, or the like) for storing the policy and rules templates 210.

Each of the one or more policy and rules templates 210 may be a pre-defined and validated template associated with one or more usage scenarios and policy constraints (e.g., the network policies and/or virtual service rules). For example, a template such as “inbound-networkpolicy-template” may be designed for implementation of public APIs, external APIs, and/or internal APIs while a template such as “private-networkpolicy-template” may be designed for implementation of private APIs.

Any number of policy and rule templates 210 may be stored in the policy and rules repository 208 based on policies and rules set by (or associated with) one or more entities that maintain the service infrastructure 110. The policy and rules repository 208 may also include policy and rules templates 210 for all type of deployment environments such that the intent-based policy generation process of embodiments disclosed herein may advantageously be agnostic to all known and/or existing deployment platforms.

In embodiments, each of the one or more policy and rules templates 210 may also include one or more types of symbolic names. For example, a first symbolic name may be presented as a first syntax and may be resolved by one or more development tools (e.g., available in the service infrastructure 110) at a computer implemented service's (e.g., microservice's) development time. As another example, a second symbolic name may be presented as a second syntax (different form the first syntax) and may be resolved by a continuous delivery/continuous deployment (CD) pipeline at the computer implemented service's (e.g., microservice's) deployment time.

Having two such symbolic names advantageously allow sharing of a common set of policies and rules across development, staging, pre-production, production, deployment environments, or the like.

After the one or more policy and rules templates 210 are retrieved from the policy and rules repository, the retrieved policy and rules templates 210 and request data (e.g., the service management request 200) may be provided (as part of the intent conversion process 206) to a service management instruction generation process 212.

In embodiments, the service management instruction generation process 212 may be performed by any of the devices discussed above in FIG. 1. As part of the service management instruction generation process 212, the retrieved policy and rules templates 210 are automatically completed (e.g., filled in, populated, or the like) using information associated with the (new and/or existing) computer implemented services (and/or instances of the computer implemented services) (to be deployed and/or updated/modified) included in the service management request 200. Automatically completing the policy and rules templates 210 may include replacing the first and second symbolic names (and other parameters, blank spaces, placeholders, or the like within the one or more retrieved policy and rules templates 210) with specific information associated with the requested computer implemented services included in the service management request 200.

In embodiments, the generated service management instructions may then include the completed policy and rules templates 210 as well as all other data/information (e.g., instructions) required for the computer implemented service(s) to be deployed (or updated/modified) based on the original intent of the developer. Said another way, the generated service management instructions may include a set of user intended policy and rules generated based on completing the retrieved policy and rules templates 210 with the information associated with the requested computer implemented services.

The generated service management instructions may then be provided to one or more of the service devices (e.g., 112-114) of the service infrastructure 110 to be applied (e.g., executed by) the receiving service devices. As a result, the receiving service devices may be caused to apply the set of user intended policy and rules to one or more existing or new services (and/or instances) of the services. In embodiments, the one or more existing or new services (and/or instances) applied with the set of user intended policy and rules may be provided to the client device.

As discussed above, the components of FIG. 1 may perform various methods to manage services (e.g., the development, deployment, and configuration of services). FIG. 3 illustrates a method that may be performed by the components of FIG. 1.

Additionally, in the diagram discussed below and shown in FIG. 3, any of the operations may be repeated, performed in different orders, and/or performed in parallel with or in a partially overlapping in manner with one or more other operations.

Turning now to FIG. 3, a flow diagram illustrating a method for managing services (namely, the development, deployment, and configuration of services) in accordance with an embodiment is shown. The method may be performed by any of the client device 102, the service devices (e.g., 112-114) of the service infrastructure 110, the service infrastructure manager 116, and/or any other components of the system shown in FIG. 1.

At operation 300, as discussed above in reference to FIG. 2, a service management request (e.g., 200 of FIG. 2) may be obtained. In embodiments, the service management request may be obtained by a service infrastructure manager (or any one of the service devices (e.g., 112-114 of FIG. 1) of the service infrastructure 110) from a client device. In another example, the service management request may be obtained by the client device 102 of FIG. 1 from another client device connected to the communication system 130.

At operation 302, as discussed above in reference to FIG. 2, the service management request may be parsed (e.g., as part of the intent conversion process 206 of FIG. 2) to obtain intent data. The parsing of the service management request may be performed using any type of data identification techniques (e.g., identifying tags, natural language processing techniques, or the like).

At operation 304, as discussed above in reference to FIG. 2, the intent data may be used (e.g., as part of the intent conversion process 206 of FIG. 2) to obtain one or more policy and rules templates from a policy and rules repository.

At operation 306, as discussed above in reference to FIG. 2, the one or more policy and rules templates and the intent data (as well as all other data included in the service management request obtained in operation 300) may be used (e.g., as part of service management instruction generation process 212) to generate service management instructions.

In embodiments, the service management instructions may include a set of user intended network policy and rules generated by completing (e.g., filling in, or the like) the one or more policy and rules templates based on the intent data (as well as all other data included in the service management request obtained in operation 300).

At operation 310, the service management instruction may be provided to one or more service devices of the service infrastructure for application of the set of user intended policy and rules by the one or more services devices.

The method may end following operation 310.

In embodiments, the client device (or any other device) receiving the service management request may not have access to any policy and rules included in the one or more policy and rules templates stored in the policy and rule repository for guiding a user of the client device (e.g., a developer) during the generation of the service management request.

As a result, the user is advantageously able to simply declare any isolation and/or protection requirements for one or more computer implemented services without having to worry about whether the user himself/herself is able to correctly and completely implement policy configurations for the one or more computer implemented services (and without having to look through various instruction manuals, guidelines, or the like for configuration of such policies (e.g., network policies and/or virtual service rules)).

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing services, the method comprising:
obtaining a service management request;
parsing the service management request to obtain intent data;
using the intent data to obtain one or more policy and rules templates from a policy and rules repository;
generating service management instructions using the one or more policy and rules templates and the intent data, the service management instructions comprising a set of user intended network policy and rules; and
providing the service management instructions to one or more service devices providing the services to cause the one or more service devices to apply the set of user intended network policy and rules to one or more existing or new instances of the services.

2. The method of claim 1, wherein the intent data is associated with at least one of a service visibility configuration, a service accessibility configuration, or a service control configuration of the services.

3. The method of claim 2, wherein parsing the service management request to obtain intent data comprises:
parsing a natural language statement or information associated with a human action or selection included in the service management request, the natural language statement or the information associated with the human action or selection comprising at least one of a service visibility intent, a service accessibility intent, or a service control intent that affects the service visibility configuration, the service accessibility configuration, or the service control configuration, respectively, of the services.

4. The method of claim 3, wherein each of the one or more policy and rules templates comprises at least one of a first symbolic name or a second symbolic name.

5. The method of claim 4, wherein the first symbolic name is resolved by a service development tool at a service development time and the second symbolic name is resolved by a continuous delivery/continuous deployment (CD) pipeline at a service deployment time.

6. The method of claim 5, wherein the set of user intended network policy and rules constructed from the one or more policy and rules templates are associated with at least one of public application programming interfaces (APIs), external APIs, internal APIs, or private APIs.

7. The method of claim 6, wherein the service management request is obtained from a client device requesting the services provided by the one or more service devices, the one or more existing or new instances of the services applied with the set of user intended network policy and rules are provided to the client device, and the client device does not have access to any policy and rules included in the one or more policy and rules templates stored in the policy and rules repository for guiding a user of the client device during a generation of the service management request.

8. A non-transitory machine-readable medium having instructions stored therein, which when executed by a processor, cause the processor to perform operations for managing services, the operations comprising:
obtaining a service management request;
parsing the service management request to obtain intent data;
using the intent data to obtain one or more policy and rules templates from a policy and rules repository;
generating service management instructions using the one or more policy and rules templates and the intent data, the service management instructions comprising a set of user intended network policy and rules; and
providing the service management instructions to one or more service devices providing the services to cause the one or more service devices to apply the set of user intended network policy and rules to one or more existing or new instances of the services.

9. The non-transitory machine-readable medium of claim 8, wherein the intent data is associated with at least one of a service visibility configuration, a service accessibility configuration, or a service control configuration of the services.

10. The non-transitory machine-readable medium of claim 9, wherein parsing the service management request to obtain intent data comprises:
parsing a natural language statement or information associated with a human action or selection included in the service management request, the natural language statement or the information associated with the human action or selection comprising at least one of a service visibility intent, a service accessibility intent, or a service control intent that affects the service visibility configuration, the service accessibility configuration, or the service control configuration, respectively, of the services.

11. The non-transitory machine-readable medium of claim 10, wherein each of the one or more policy and rules templates comprises at least one of a first symbolic name or a second symbolic name.

12. The non-transitory machine-readable medium of claim 11, wherein the first symbolic name is resolved by a service development tool at a service development time and the second symbolic name is resolved by a continuous delivery/continuous deployment (CD) pipeline at a service deployment time.

13. The non-transitory machine-readable medium of claim 12, wherein the set of user intended network policy and rules constructed from the one or more policy and rules templates are associated with at least one of public application programming interfaces (APIs), external APIs, internal APIs, or private APIs.

14. The non-transitory machine-readable medium of claim 13, wherein the service management request is obtained from a client device requesting the services provided by the one or more service devices, the one or more existing or new instances of the services applied with the set of user intended network policy and rules are provided to the client device, and the client device does not have access to any policy and rules included in the one or more policy and rules templates stored in the policy and rules repository for guiding a user of the client device during a generation of the service management request.

15. A data processing system comprising:
a processor; and
a memory, wherein the memory stores instructions that when executed by a processor cause the processor to perform operations for managing services, the operations comprising:
obtaining a service management request;
parsing the service management request to obtain intent data;
using the intent data to obtain one or more policy and rules templates from a policy and rules repository;
generating service management instructions using the one or more policy and rules templates and the intent data, the service management instructions comprising a set of user intended network policy and rules; and
providing the service management instructions to one or more service devices providing the services to cause the one or more service devices to apply the set of user intended network policy and rules to one or more existing or new instances of the services.

16. The data processing system of claim 15, wherein the intent data is associated with at least one of a service visibility configuration, a service accessibility configuration, or a service control configuration of the services.

17. The data processing system of claim 16, wherein parsing the service management request to obtain intent data comprises:
parsing a natural language statement or information associated with a human action or selection included in the service management request, the natural language statement or the information associated with the human action or selection comprising at least one of a service visibility intent, a service accessibility intent, or a service control intent that affects the service visibility configuration, the service accessibility configuration, or the service control configuration, respectively, of the services.

18. The data processing system of claim 17, wherein each of the one or more policy and rules templates comprises at least one of a first symbolic name or a second symbolic name.

19. The data processing system of claim 18, wherein the first symbolic name is resolved by a service development tool at a service development time and the second symbolic name is resolved by a continuous delivery/continuous deployment (CD) pipeline at a service deployment time.

20. The data processing system of claim 19, wherein the set of user intended network policy and rules constructed from the one or more policy and rules templates are associated with at least one of public application programming interfaces (APIs), external APIs, internal APIs, or private APIs.
